(19) United States
(12) Patent Application Publication
(10) Pub. No.: US 2026/0048610 A1
(43) Pub. Date: Feb. 19, 2026

(54) Rotatable Pattern Device with Method

(71) Applicant: Robert D. Barbeau, Clementon, NJ (US)

(72) Inventor: Robert D. Barbeau, Clementon, NJ (US)

(21) Appl. No.: 18/807,226

(22) Filed: Aug. 16, 2024

Related U.S. Application Data
(60) Provisional application No. 63/552,217, filed on Feb. 12, 2024.

(51) Int. Cl. B44C 1/18; G09F 11/02

(52) U.S. Cl. CPC B44C 1/18; G09F 11/02

(57) ABSTRACT

The present invention relates to a boxed kit containing all components necessary to assemble a decorative device; present invention relates to a decorative device comprising a series of rotatable hollow cylinders inset within a small picture frame. Each cylinder is supported by an elongated dowel pin secured by a central bead plug, allowing for free rotation within the frame. The surface of each cylinder is decorated using a spiral method, creating intricate fractal patterns. This design offers dynamic visual effects and versatile applications, making it suitable for use as an art piece, interactive toy, or decorative display. The device combines mechanical simplicity with aesthetic complexity, providing an engaging and customizable decorative solution.

### TECHNICAL FIELDS: ART AND DESIGN, SECURITY

### Background of the Invention

Decorative devices have long been used to enhance the aesthetic appeal of various environments. Traditional methods of creating decorative patterns often involve complex and time-consuming techniques, limiting their accessibility and versatility. The need for a simple, yet effective method for creating dynamic and visually engaging decorative patterns has led to the development of innovative solutions.

The present invention addresses this need by providing a decorative device featuring rotatable hollow cylinders housed within a picture frame. This device utilizes rotatable elements consisting of configurable patterns to create intricate fractal patterns on the surface of the cylinders, offering a unique and customizable decorative solution. The inclusion of pre-cut paper sleeves simplifies the decoration process, making it accessible to users of all skill levels. The device's ability to rotate the decorated cylinders adds a dynamic visual element, enhancing its appeal as a novelty. The invention combines mechanical simplicity with aesthetic complexity, providing a versatile and engaging tool for creating captivating decorative patterns.

My main objective is to market a boxed kit with contents as reference on page 13.

A second objective and variation for use of the rotatable pattern device with method is to implement the device's beneficial potential in the security markets. The rotatable pattern device with method can reduce the overall cost of security procurement through its straightforward approach to security and development.

Security systems rely on unpredictability and uniqueness to protect against unauthorized access. The device applies here as follows:
Endless Pattern Combinations: The novel device generates an infinite number of non-repetitive patterns, making it difficult for unauthorized entities to predict or replicate.
Randomness as a Defense Mechanism: Cryptographic systems, biometric security, and authentication methods thrive on randomness. The novel device's ability to produce randomized, non-repetitive sequences could be harnessed for these purposes.
Non-Algorithmic Generation: Unlike conventional digital security measures that rely on predictable mathematical algorithms (which can be hacked), the device's physical system introduces an organic randomness, enhancing security.

### SUMMARY OF PATTERN DEVICE WITH METHOD

Rotatable Cylinders:
   The device consists of multiple hollow cylinders arranged in a row.
   These cylinders are designed to rotate independently around a central axis, facilitated by the elongated dowel pin.
   The rotation allows for interactive manipulation, enhancing the decorative appeal.
Picture Frame:
   The frame is small and designed to hold the cylinders securely.
   It can be made from various materials such as wood, metal, or plastic, depending on aesthetic and functional requirements.
   The frame provides a border, ensuring the cylinders remain aligned and contained.
Center Bead Plug and Elongated Dowel Pin:
   The center bead plug ref. FIG. 2 is a critical component that anchors the elongated dowel pin within the frame.
   The dowel pin passes through the center of each cylinder allowing them to rotate around it.
   This design ensures smooth and stable rotation of the cylinders.
Spiral Method and Fractal Patterns:
   The spiral method involves decorating the surface of each cylinder with a spiral design.
   Using a wrapped paper sleeve on a cylinder illustrated in FIG. 2 is similar to a cylindrical canvas ready for an applied decoration.
   This can be achieved through various techniques such as engraving, painting, or molding.
   The resulting fractal patterns are visually striking, creating a sense of depth and complexity.
   These patterns can be customized to vary in size, scale, and complexity, allowing for a wide range of decorative effects.

### APPLICATIONS AND BENEFITS

The device can be used for various decorative purposes, including as a unique piece of art, a visually engaging toy, or an interactive display.
The rotatable cylinders and fractal patterns provide a dynamic and ever-changing visual experience.
The design is versatile and can be adapted for different sizes, materials, and aesthetic preferences.

### PRIOR ART CITED

### US20050129314A1—at FIG. 7 Page 20

Prior art is similar in scope as the three bases of a triangle are implemented within a computerized application patent. In comparison with the prior art and the Method used with the Novel Pattern Device both are consistent with the use of a geometrical triangle

Cited at Espace.net

US2014025353A1

Prior art is similar and consistent with the inversion of images through a fractal composition process

Cited espace.net

1 Method for Generating a Non-Periodic Visual Pattern

WO2005026863A2(A3)—2005-03-24—Studio Tampa Inc [CA]

Detailed description of the Device with Method The new invention is a mechanical hands-on device with Method able to generate patterns and fine artwork on a rolling picture plane. The device can be hand-held laid flat or wall hung. The novel invention is lightweight, made with green materials and economical to produce commercially. The Spiral Method as illustrated in FIG. 1 33 thru 41 is shown in reference to an effective learning method on the cylinders.

The Spiral Method is also referenced in the box kit contents on page 13.

In relevance The Novel Pattern Device with Method uses fractals and the Pythagorean theorem of a triangle's “equilibrium of unities.” The triangular form is exemplified as formed from two separate cylinder parts to become a pair of opposite drawn spiral lines on paired right cylinders as shown in the embodiment of FIG. 1 24 and 25 to form two side bases of a triangle with a third base being implied or drawn in decoration as a horizon or baseline. The invention will produce a new pattern that is out-pictured from a row of rotatable cylinders in a given matrix.

A composition at rest may be photographed, stored and then recollected on the device through comparisons with the photo taken.

Each cylinder within a specific set of cylinders has its own use and specific decorated character in a set. See FIG. 1 33/41.

In comparison with the use of a flat canvas surface suitable for one piece of artwork, the novel pattern device with method invention contains a distinct and capable rolling surface that allows for each part within the cylinder body to have independent movement specifically rotatable, can pivot and will change a present stayed image of an out-picture to an altered image of the present image. A further observation of discovery in the device and method shows the altered image out-picture can appear distinctly different from the previous image.

Because it is not possible to see entirely around a cylinder without moving it in a circular direction, some of the cylinders' technical specifications are of importance in mentioning. Our 3D rotating earth revolves on its axis and has 4 hemispheres. A cylinder being 3D also consists technically of two hemispheres. The two spheres shown on a right cylinder are equally divided with an adaptation by forming a meridian line from base to base. A vertically positioned right cylinder with a spiral line drawn as spiraled from a starting 90 degree angle axis point at top base to an ending 90 degree angle axis point at bottom base forms the separation of the hemispheres. They appear up and down and also left and right. Each pair of cylinders form a unified field in a triangular fractal formation shown in

FIG. 1 “24 and 25” as a pair and consisting of the Method applied to the paired cylinders.

Making visual art directly on a cylinder by hand requires a special skill and technique. Because of a cylinder's roundness it is difficult to pinpoint accuracy when attempting to draw onto a rounded surface by hand. A procedure of making decorative art with the invention's Method on flat paper or any other bendable material and then wrapping the decorated paper as a sleeve on a cylinder as in FIG. 2 is a much easier task and produces end results quickly. The learning curve is greatly increased. FIG. 1 24 thru 32″ as shown in the embodiment of FIG. 1 and in FIG. 2 of cylinder with embodiment of FIG. 2 paper sleeve, and center bead plug.

Using two right cylinders I have refined a spiral technique using 2 opposite directional poles to make a pair. Pairs of two cylinders sampled here as / \ / \ / \ three pairs are showing. The pair's are exemplified in comparison to FIG. 1 cylinders 24/32 shown in the tilted lines on the cylinders as the spiral method FIG. 1 33/41.

The spiral method technique can be explained as the primary basic principle with a fundamental approach to understanding this new art format. In omitting the Spiral Method The Pattern Device would be searching for this ideal new learning technique. FIG. 1 34/41 shows a single view of the spiral method technique and is shown as a single visual viewed for reference purposes only. When the cylinders are rotated on the Device a near infinite variation of visuals may be possible all stored within the unfolding composition on the cylinders implementing the Spiral Method.

Technically using the theorem of the “equilibrium of unities” the above three pairs now consist of 5 qualifying unified fields. The pattern device with method allows pair sharing in triangular lines to form the fractals. The Method allows cylinder sharing in forming fractal triangular patterns in side parts. The visual outcome have Up-Down-Up Pattern or right-left-right pattern as shown in the embodiment of FIG. 1 as the embodiment of the Method 33 thru 41. The tilted lines shown are the spiral directions as placed on cylinders. and not excluding variations where each pair forms a unified field as above, and not excluding other variations of pattern either unified, or free style meaning also semi unified. Variations in patterns like / \ \ / / \ / / / . . . are also acceptable. It is the artist's talent and expertise that will make an impressive work using the Method's circular format to form extraordinary out-pictures. A fortunate stroke of serendipity is another quality that becomes second nature to its beauty in a composed new scene through a rotation of easy individual hand movement.

The cylinders are set within a picture frame as shown in the embodiment FIG. 1 24 thru 32. Each cylinder within a composed set has free rotation, can pivot and utilizes kinetic energy. The Method as shown in the embodiment of FIG. 1. 33 thru 41 implements a spiral pattern that separates the whole given surface space on a right cylinder forming a meridian into the 2 hemispheres and in effect two viable fields that can be decorated. The fields can produce new art design patterns through fractal component variations formed by the Method via the Device's rotational capabilities.

A horizontal baseline implied will form a third base of a unified field forming a single abstract implied moveable triangle in scale and placement on each paired cylinder's surface as one triangle. As shown in the embodiment of FIG. 1 33 thru 35. Fig

### DESCRIPTION OF DRAWINGS

FIG. 1 depicts the complete embodiment of the Novel Pattern Device with Method, comprising components numbered 2 through 41. Parts 2 and 5 represent the frame sections, consisting of two sides used as the top and bottom of the frame. These parts feature drilled pilot holes that align with each other to securely hold the center pins in place. Parts 3 and 4 are shown as the two remaining sides of the frame. When fully assembled, these four parts come together at right angles to form a perfect rectangular frame.

Parts 6 through 14 are illustrated as dowel center pins, which are positioned in the bottom base of the cylinders numbered 24 through 32 and inserted into selected pilot holes within the complete embodiment. Similarly, parts 15 through 23 serve as dowel center pins located in the top base of cylinders 24 through 32, also placed into selected pilot holes within the full assembly. The cylinders themselves, numbered 24 through 32, form the main body of the device and represent critical elements of the complete embodiment.

Finally, parts 33 through 41 illustrate the application of the Method on cylinders 24 through 32. Each cylinder is decorated with spiraled lines, alternating in left and right directions, with the exception of cylinders 26 and 27, which share the same rightward spiral pattern. Each cylinder is marked with a single spiraled line, contributing to the overall design and function of the complete embodiment.

FIG. 2 illustrates an embodiment consisting of a cylinder wrapped with a paper sleeve featuring a glued edge and an embedded center bead plug located at both the top and bottom bases of the cylinder. For a summary of the pattern device with method, refer to page 3. A detailed description of this embodiment is provided in reference to FIG. 2 on page 8. Additionally, the paper sleeve is mentioned in the box kit contents on page 12.

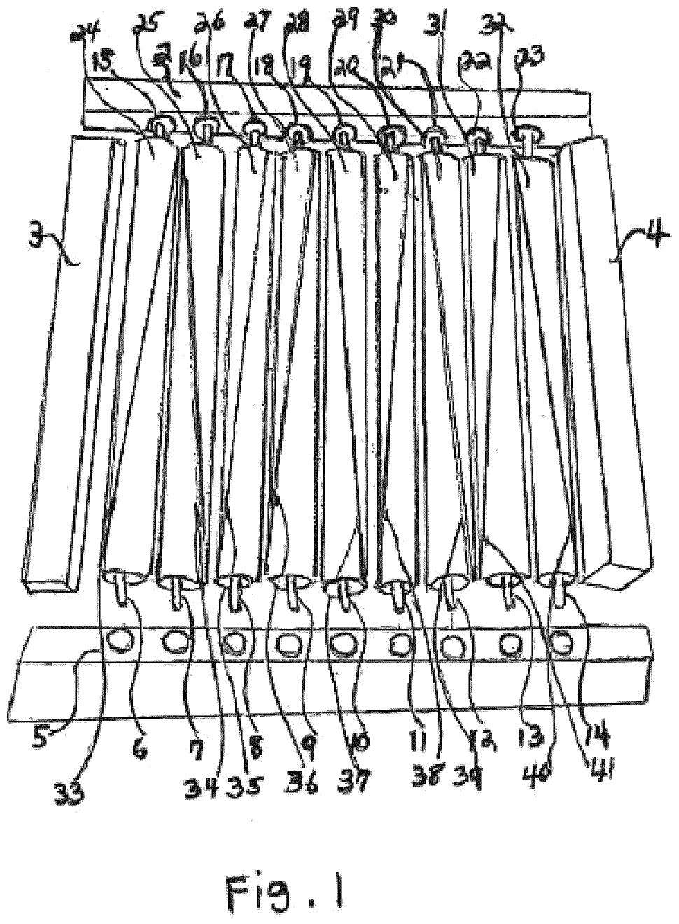

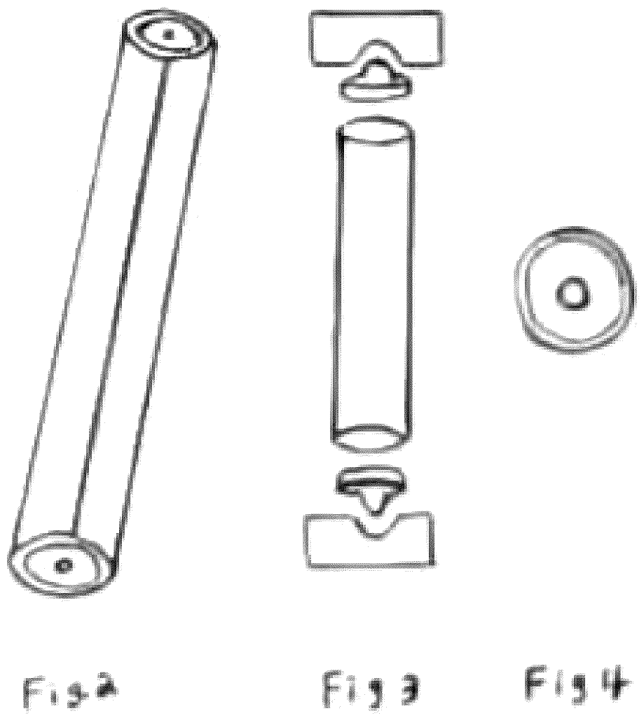

FIG. 3 depicts an embodiment of a frame section consisting of top and bottom frame parts, each having grooved niches designed to house center nodes. This embodiment includes a cylinder with a tapered base plug and a center node, offering an alternative and replacement option for the embedded center bead plug shown in FIG. 2. The frame parts in FIG. 1, specifically parts 2 and 5 with drilled pilot holes and dowel pins 6 through 23, could be substituted with the matching grooved niches in the frame part and the tapered plug with center node from FIG. 3. By utilizing the embodiment in FIG. 3 as an alternative method to secure the rotatable cylinders within the frame, assembly time for the device can be significantly reduced.

FIG. 4 illustrates an embodiment consisting of a flush-mounted tapered base plug with a center hollow, designed as a substitute for the center bead plug used in the embodiment of FIG. 2. This replacement plug is also compatible with the assembly shown in FIG. 1. The use of the plug depicted in FIG. 4 is intended to enhance assembly efficiency, particularly in a commercial production setting of the Novel Pattern Device with Method. Made from plastic or resin composite, this component reduces assembly time due to its streamlined design and ease of manufacture.

### DESCRIPTION: BOXED KIT CONTENTS

Rotatable Cylinders: A set of hollow cylinders, each capable of free rotation around its longitudinal axis.

Picture Frame: A small frame designed to house the cylinders, made from durable materials such as wood, metal, or plastic.
Center Bead Plugs: Plugs to secure the elongated dowel pins within the hollow cylinder.
Elongated Dowel Pins: Pins that extend through the hollow centers of the cylinders, serving as the axis for rotation.
Paper Sleeves: Pre-cut paper sleeves designed to fit over the cylinders for easy decoration. Ref. FIG. 2
Art Supplies: Paints, brushes, engravers, or other tools necessary for applying the spiral design to the cylinders and sleeves.
Assembly Instructions: Step-by-step guide to assembling the device.
Art Method Techniques Manual: Instructions for decorating the cylinders and paper sleeves using the spiral method ref. FIG. 1 33/41.

2. Assembly Instructions:
Step 1: Device equipped with Preassembled Frame and preset base plug in cylinder
   Unpack the picture frame and components.
   Locate cylinders and dowels and sleeves
   Decoration on paper sleeves follow how to instruction manual using a spiral method
Step 2: procedure for placing working on a table ; drop and side tap the cylinder to drop thru to the cylinder bottom base on flat surface. In a standing frame thread the top of the dowel in a top pilot hole and place the base end of the cylinder in the frame at its matching pilot hole. When set the dowel will recess into the frame; repeat the process to add cylinders
Step 3: Securing the Dowel Pins: cover the open pilot holes with clear tape to secure
Step 4: Final Adjustments Ensure all components are securely in place and that the cylinders rotate smoothly.

3. Art Method Techniques:
Step 1: Preparing the Sleeves for decoration
   Align as a set on a flat surface
   Number each sleeve. 1 thru 9
   Use the spiral method to form pairs of opposite directional lines meaning 2 sleeves to each pair following through for the entire set of sleeves
Step 2: Decorating the Paper Sleeves
   Using the provided art supplies, apply a spiral design to the surface of each paper sleeve.
   Techniques can include drawing, painting, engraving, or other decorative methods.
Step 3: Creating Fractal Patterns
   Follow the instructions in the manual to create intricate fractal patterns using the spiral method on the paper sleeves.
   Adjust the size, scale, and complexity of the patterns as desired.
Step 4: Drying and Finishing
   Allow the decorated paper sleeves to dry completely if paint or other wet materials are used.
   Apply any finishing touches as recommended in the art techniques manual.
   Once dry, reapply the decorated sleeves to the cylinders if removed during the decoration process.

4. Applications and Benefits:
The assembled device can be used as a unique piece of art, a visually engaging toy, or an interactive display.
The rotatable cylinders and fractal patterns provide a dynamic and ever-changing visual experience.
The paper sleeves allow for easy and customizable decoration, making it accessible for users of all skill levels.
The kit is versatile and can be adapted for different sizes, materials, and aesthetic preferences.

1. I claim a Boxed Kit for a Novel Pattern Device consisting in the embodiment
a plurality of hollow cylinders, each capable of free rotation around its longitudinal axis;
a picture frame configured to house the plurality of hollow cylinders;
center bead plugs for securing elongated dowel pins within the picture frame;
elongated dowel pins extending through the hollow centers of the cylinders, allowing the cylinders to rotate freely;
pre-cut paper sleeves designed to fit over the hollow cylinders for easy decoration;
a set of art supplies for applying a spiral design to the paper sleeves and/or cylinders;
an instruction manual providing step-by-step assembly instructions and art method techniques for creating fractal patterns using the spiral design.

2. The decorative device kit of claim 1, wherein the picture frame is made from materials selected from the group consisting of wood, metal, and plastic.

3. (canceled)

3. The decorative devise of claim 1, wherein the art supplies comprise at least one paint medium, at least one marking implement, and adhesive materials, together with printed instructional sheets describing step by step decoration techniques for applying spiral or other geometric designs to the precut paper sleeves, and or / cylinders.

4. A method of assembling the decorative device kit of claim 1, comprising:
Pre assembled Frame: consisting with sets of matching pilot holes in top and bottom frame parts;
placing the hollow cylinders with a threaded dowel adapting to center bead plug into designated pilots within the picture frame to ensure free rotation of the cylinders;
Wrapping a decorated pre-cut paper sleeve over the hollow cylinders for decoration.

5. A method of decorating the hollow cylinders of the decorative device kit of claim 1, comprising:
Unpacking the set of sleeves ; use a work table to align a row of sleeves for decoration ;
applying a spiral design to the paper sleeves using the provided art supplies;
following instructions in the manual to create intricate fractal patterns with the spiral design;
allowing the decorated paper sleeves to dry completely before final assembly.
Carefully wrap the decorated paper sleeve on the cylinder then glue at line and adhere.

6. The decorative device kit of claim 1, wherein the assembled device is used as a decorative display, an art piece, or an interactive toy, featuring dynamic visual effects through the rotation of the decorated cylinders.

7. (canceled)

7. The decorative device kit in claim 1, wherein the center bead plug comprises a replaceable tapered base plug having a central node, the plug being configured to seat within a corresponding recess in the picture frame, and manufactured from a durable plastic or resin composite to allow repeated removal and replacement without loss of fit.

8. (canceled)

8. The decorative device kit in claim 1, wherein the center bead plug comprises a replaceable flush-mount tapered base plug having a central hollow sized to receive a dowel pin, the plug being manufactured from a durable plastic or resin composite and configured to permit removal and replacement without damaging the frame or the plug.

9. I claim a security device comprising:
Rotatable Pattern Device
Functions as a random pattern generator
Utilizes bi-directional rotatable cylinders to create unpredictable patterns
Security Application
Capable of generating random patterns for authentication or encryption purposes
Potential use in visual security systems
Applicable in banking, technology, and government sectors
Method of Operation
Users rotate cylinders to form unique, non-replicable patterns
Patterns can be used for access control, identification,
